(19) United States
(12) Patent Application Publication
(10) Pub. No.: US 2008/0137993 A1
(43) Pub. Date: Jun. 12, 2008

(54) Quick cropper bag

(76) Inventor: Chin-Hsing Feng, Taoyuan Hsien (TW)

Correspondence Address: Chin-Hsing Feng, 235 Chung - Ho, Box 8-24, Taipei, omitted

(21) Appl. No.: 11/634,318

(22) Filed: Dec. 6, 2006

(51) Int. Cl. B65D 33/14; B26B 11/00; B65D 30/10; B65D 33/02

(52) U.S. Cl. 383/23; 30/124; 383/113; 383/119

(57) ABSTRACT

A quick cropper bag comprises a hollow bag having an opening end; and a sealing clip at an opening end of the bag; the sealing clip including two elastic sheets; each elastic sheet having a protrusion. Each elastic sheet is extended with a knife. The knife extends outwards from the protrusion of the elastic sheet. Each elastic sheet is extended with two projections at two sides of the knife; each projection has an inclined edge near the knives; the inclined edge can assist the knives to a correct position in cutting a fruit. An interior of the protrusion is adhered with a foam protection layer. A plurality of ribs are installed on each elastic sheet. The sealing clip is formed as a V shape. The quick cropper bag can protect a fruit in the growing period of the fruit and is helpful in the picking of the fruit.

### FIELD OF THE INVENTION

The present invention relates to croppers, and particularly to a quick cropper bag which can protect a fruit in the growing period of the fruit and is helpful in the picking of the fruit.

### BACKGROUND OF THE INVENTION

In current cropper planning, such as fruits, a protection bag is used to enclose the fruit as the fruit is small. In the prior art, the protection bag is made as a hand carry plastic bag which is a hollow bag. The bag has two long strips. In use, the hollow bag is opened for enclosing a fruit. Then the two long strips are tied to seal the opening of the bag. The operation is inconvenient, time consumed and tedious. In picking the fruit, the strips must be released, and a knife or a cutter is used to cut the stem of the fruit. However, all these operations are not efficient in time and cost.

Furthermore the cost in manpower is increase day by day, which has become a main concern in the producing of cropper. Thereby there is an eager demand for providing a novel method which can improve the above mentioned defect in the prior art way.

### SUMMARY OF THE INVENTION

Accordingly, the primary object of the present invention is to provide a quick cropper bag which can protect a fruit in the growing period of the fruit and is helpful in the picking of the fruit. The operation of the present invention is quick and easy so as to reduce the cost in manpower.

To achieve above objects, the present invention provides a quick cropper bag which comprises a hollow bag having an opening end; and a sealing clip at an opening end of the bag; the sealing clip including two elastic sheets; each elastic sheet having a protrusion. Each elastic sheet is extended with a knife. The knife extends outwards from the protrusion of the elastic sheet. Each elastic sheet is extended with two projections at two sides of the knife; each projection has an inclined edge near the knives; the inclined edge can assist the knives to a correct position in cutting a fruit. An interior of the protrusion is adhered with a foam protection layer. A plurality of ribs are installed on each elastic sheet. The sealing clip is formed as a V shape, that is a middle section of the sealing clip protrudes upwards to make the width small.

The various objects and advantages of the present invention will be more readily understood from the following detailed description when read in conjunction with the appended drawing.

### BRIEF DESCRIPTION OF THE DRAWINGS

FIG. 1 shows the perspective view of the first embodiment of the present invention.

FIG. 2 is a schematic view showing the enclosing operation in the first embodiment according to the present invention.

FIG. 3 is a schematic view showing that the application of the first embodiment of the present invention, wherein the bag is suspending to a fruit branch.

FIG. 4 shows the state of the first embodiment of the present invention, wherein the bag is hung from a fruit branch.

FIG. 5 is a cross sectional view of FIG. 4.

FIG. 6 is a structural perspective view of the second embodiment of the present invention.

FIG. 7 is a schematic cross sectional view showing the use of the second embodiment of the present invention.

FIG. 8 shows the structural perspective view of the third embodiment of the present invention.

FIG. 9 is a schematic cross sectional view about the third embodiment of the present invention.

FIG. 10 is a perspective view showing the use of the present invention.

FIG. 11 is a perspective view of the fifth embodiment of the present invention.

FIG. 12 is a schematic view showing the operation of the bag according to the fifth embodiment of the present invention.

FIG. 13 is a schematic view showing the completeness in the fifth embodiment of the present invention.

FIG. 14 is a cross sectional view of FIG. 13.

FIG. 15 is a schematic view showing the operation of the fifth embodiment.

FIG. 16 is a cross sectional view showing the operation in FIG. 15.

FIG. 17 is a schematic view showing the operation of fifth embodiment, wherein the picking operation is complete.

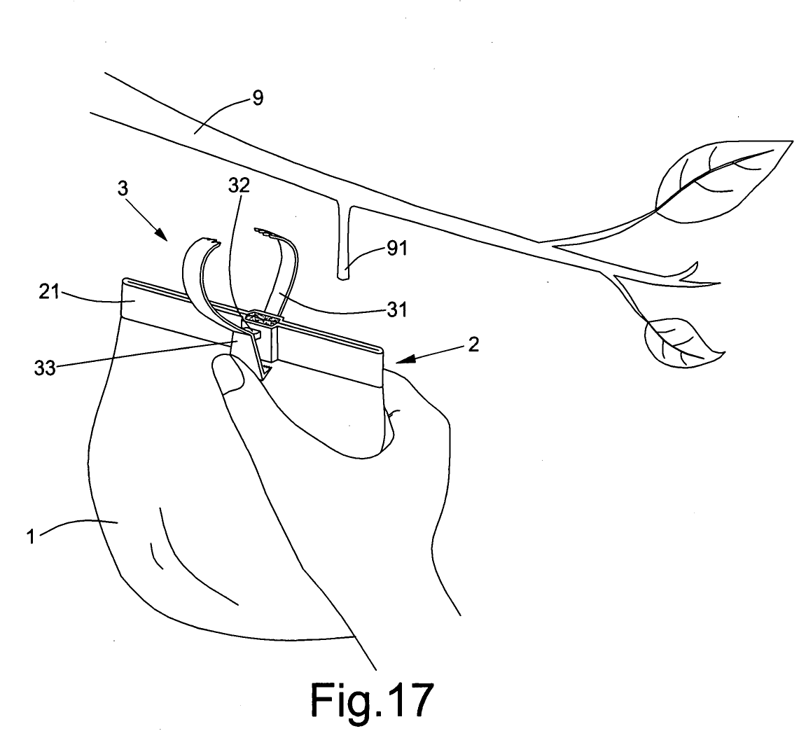

FIG. 18 is a schematic view showing the aligning block in the fifth embodiment of the present invention.

FIG. 19 is a schematic view of another embodiment of the present invention.

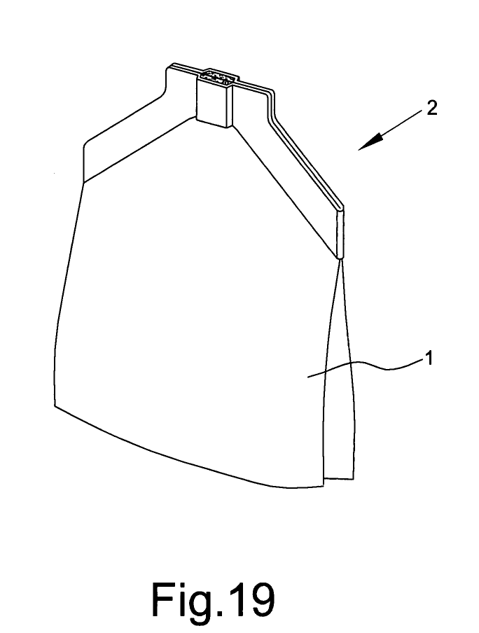

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

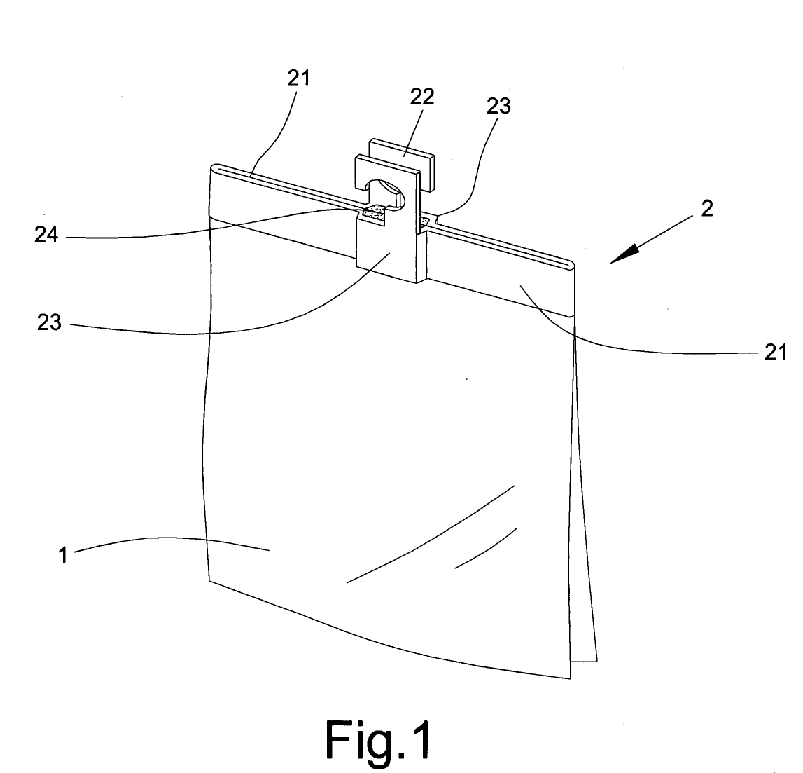

Referring to FIG. 1, the quick cropper bag of the present invention is illustrated. The present invention has the following elements.

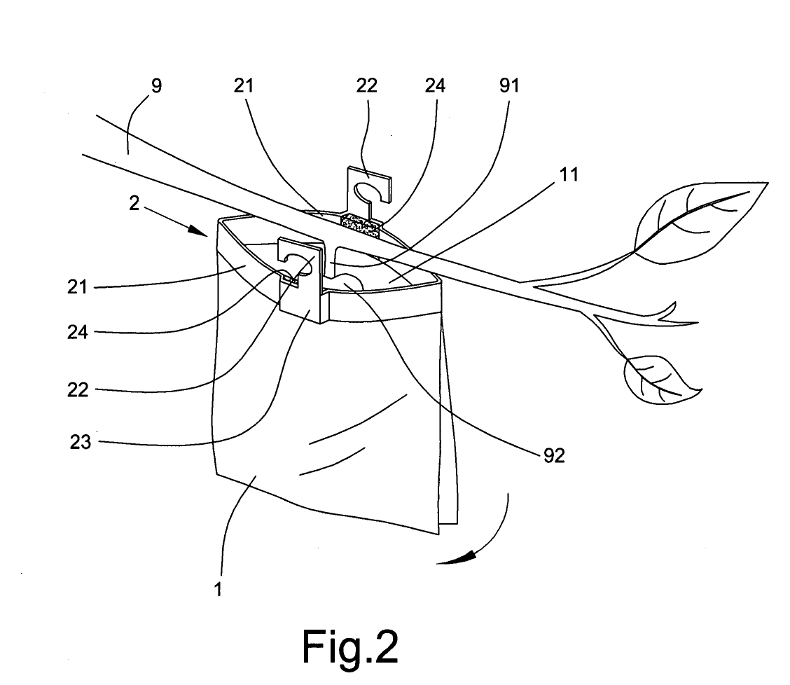

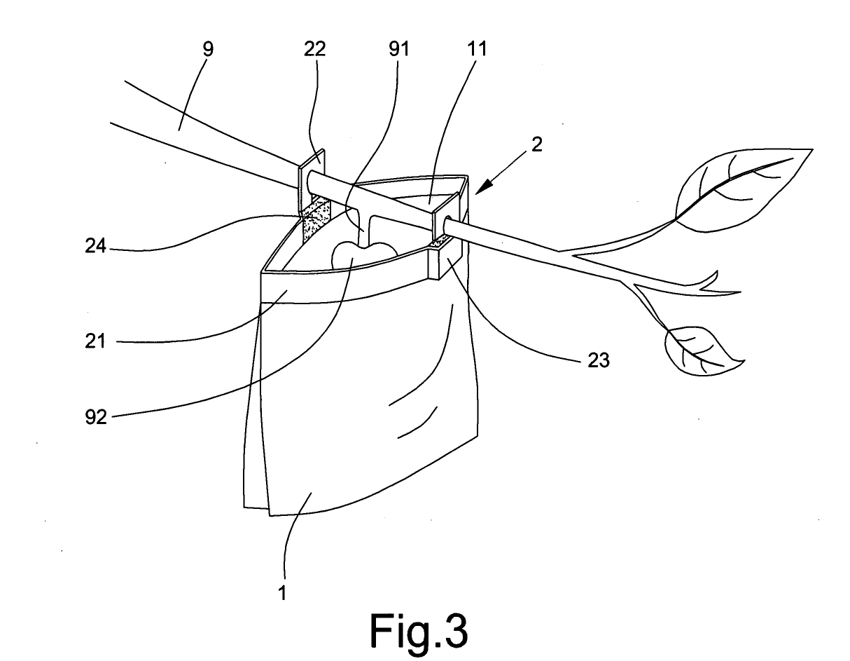

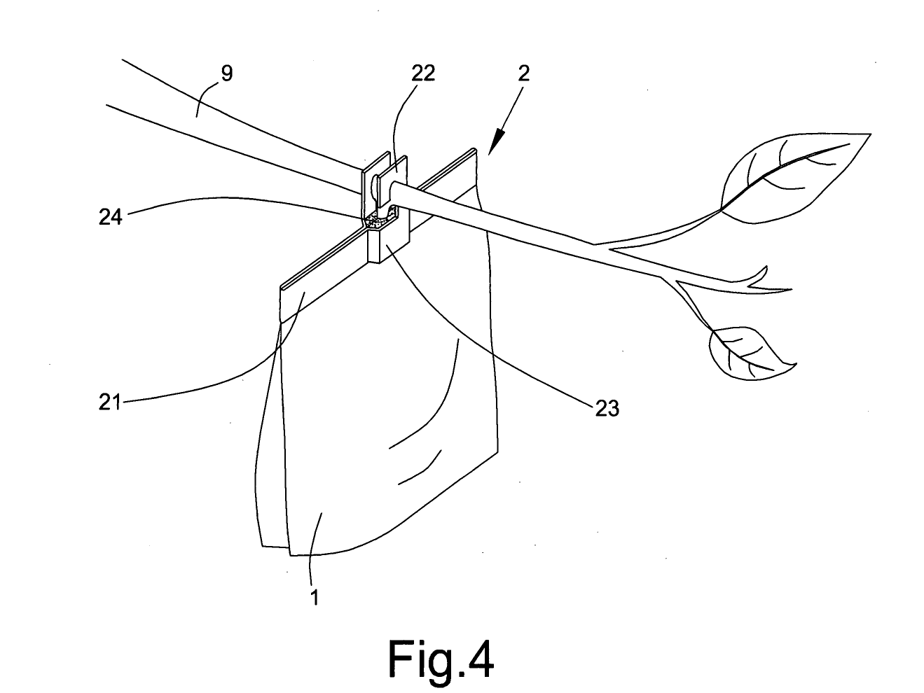

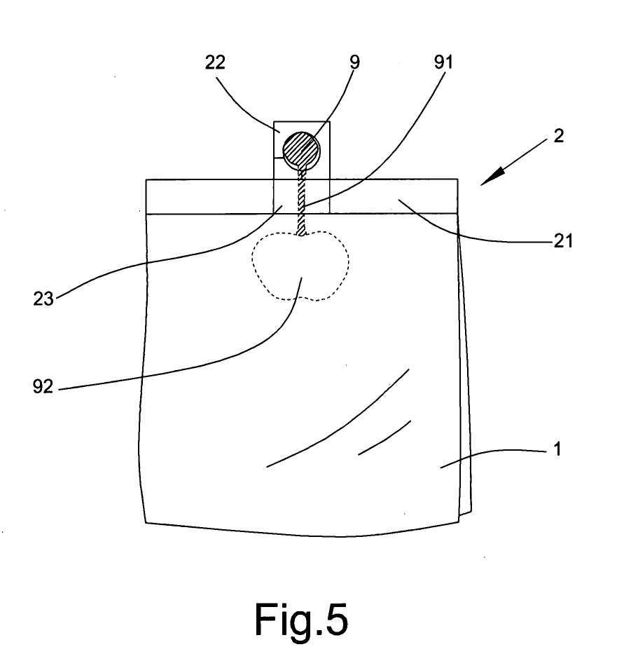

A hollow bag 1 has an opening end 11. The opening end 11 is installed with a sealing clip 2. The sealing clip 2 is formed by two elastic sheets 21. The sealing clip 2 has the effect of opening and closing. A top of each elastic sheet 21 is extended with a hook 22. Thus, when the bag 1 is used to enclose a fruit, the two ends of the clamping unit 21 are pressed by fingers so as to the elastic sheets 21 expand outwards, as shown in FIG. 2 so that the bag 1 is opened. Then the bag 1 encloses the fruit and then the orientation of the bag 1 is changed to be at a direction as illustrated in FIG. 3. Then the hooks 22 are engaged to a branch of the fruit so that the sealing clip 2 seal the opening end 11 of the bag 1 (FIGS. 4 and 5). An interior of each elastic sheet 21 can be adhered with a foam protection layer 24 to seal the gap between the two elastic sheets 21 for protecting a stem of the fruit.

To make the operation for opening the elastic sheets 21 of the sealing clip 2 conveniently, a middle section of each elastic sheet 21 is installed with a protrusion 23. An interior of each protrusion 23 is installed with a foam protection layer 24 for providing a space to receive the stem 91 of the fruit. When the two ends of the sealing clip 2 are pressed, the structure of the protrusion 23 can assist the sealing clip 2 to be opened.

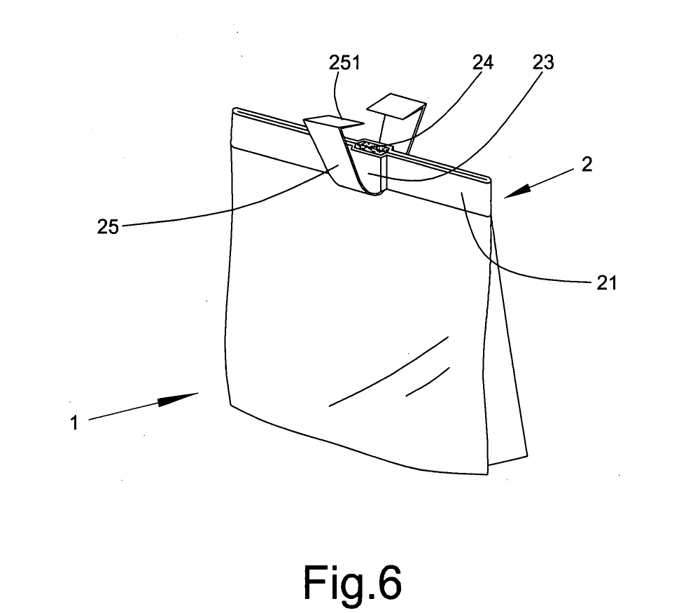

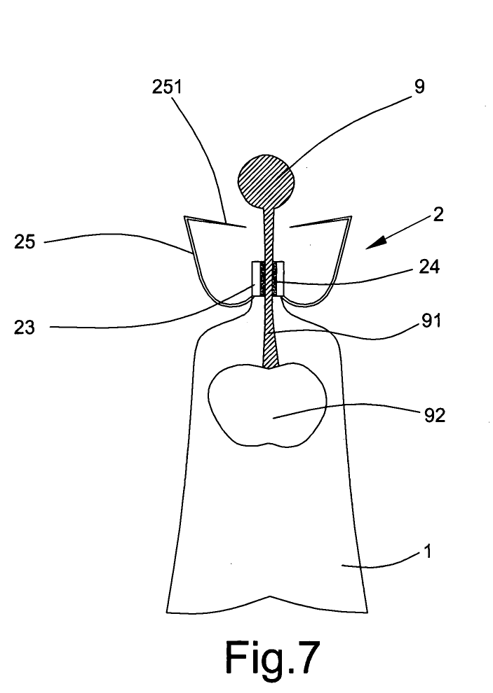

Referring to FIG. 6, it is illustrated that in the present invention, the sealing clip 2 is installed with a knife set 25. That is, each elastic sheet 21 is installed with a knife 251 which is fixed at a lower edge of the elastic sheet 21 and then extends upwards and then bended at a section above the elastic sheet 21. With reference to FIG. 7, the two knives 251 are located at two sides of the stem 91 for cutting the stem 91 as the fruit matures.

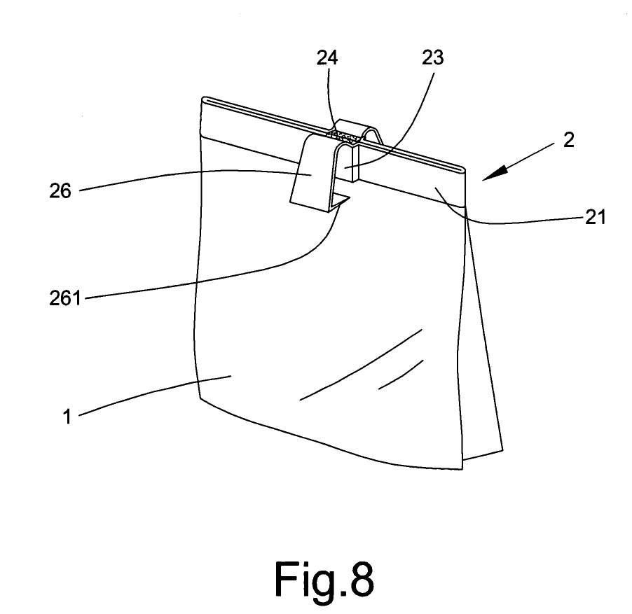

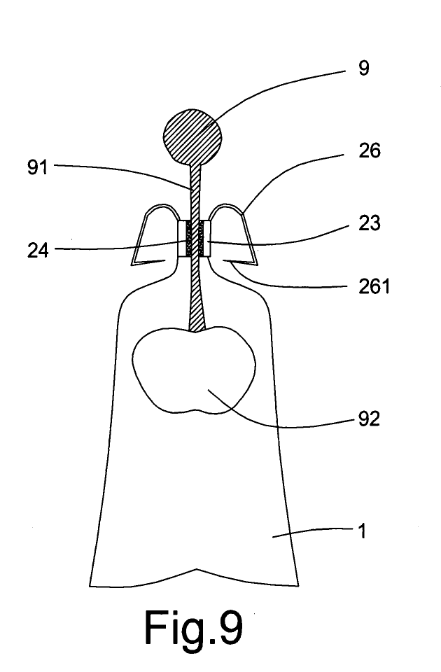

With reference to FIG. 8, another embodiment of the present invention is illustrated. The sealing clip 2 is installed with a knife set 26. That is, each elastic sheet 21 is installed with a knife 261 which is fixed at an upper edge of the elastic sheet 21 and then extends downwards and then bended at a section below the elastic sheet 21. With reference to FIG. 9, the two knives 261 are located at two sides of the stem 91 for cutting the stem 91 as the fruit matures.

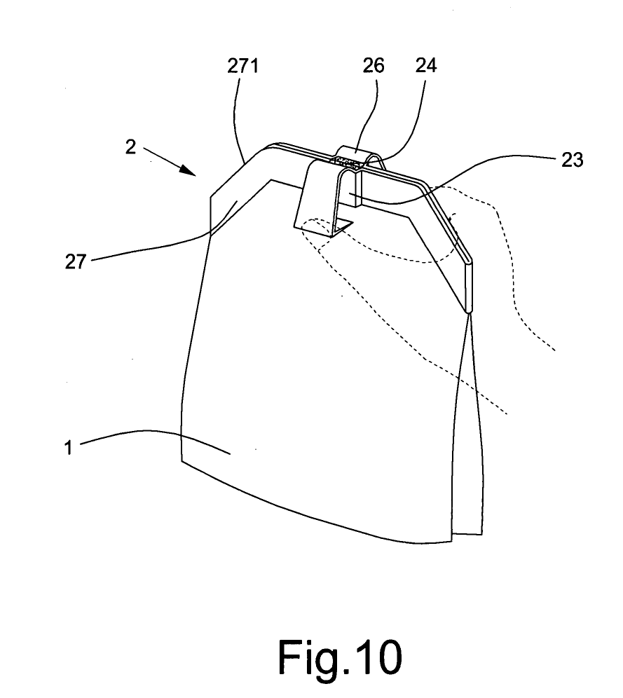

With reference to FIG. 10, in this embodiment, each of the two side of each elastic sheet 21 is bended downwards so as to be formed as a chamfered edge in the sealing clip 27. Thus, in operating the knife set 26, the sealing clip 27 will not affect the action of the user's hand.

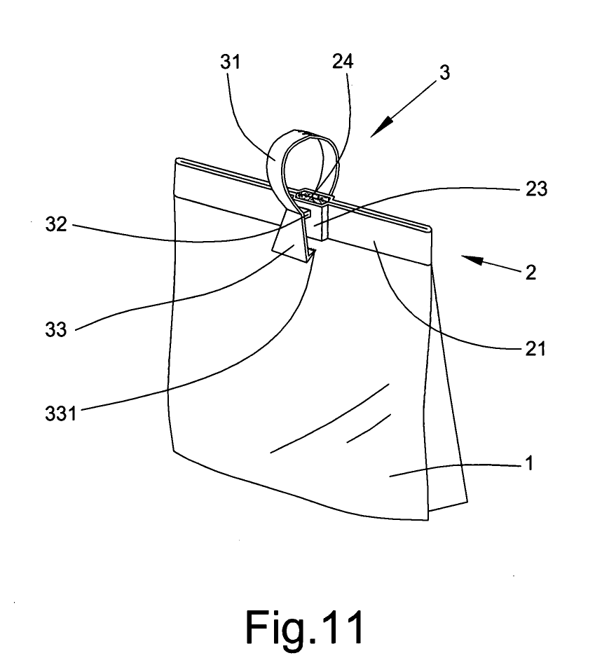

Referring to FIG. 11, another embodiment of the present invention is illustrated. The sealing clip 2 is installed with a knife set 3. That is, each elastic sheet 21 is installed with a knife 251 which is fixed at an upper edge of the elastic sheet 21 and then extends downwards and then bended at a section below the elastic sheet 21. With reference to FIG. 9, the two knives 251 are located at two sides of the stem 91 for cutting the stem 91 as the fruit matures. Each sealing clip 2 is installed with a knife unit 3. Each knife unit 3 has a base 32 installed to the elastic sheet 21. A cambered hook 31 extends upwards from the hook 32 and a knife 33 extended forwards from the base 32.

One side of the base 32 is connected to the elastic sheet 21 and is made of soft flexible material. When a force is applied to the base 32, the base 32 can slightly shift upwards or downwards.

One edge of the hook 31 is connected to the base 32 and knife 33. The hook 31 is a half-moon shape, which can be opened and closed by the operation of the base 32.

The knife 33 has a top end connected to the hook 31 and the base 32. The knife 33 has an approximate L shape and a lower end thereof is bent as a cutting edge 331.

The base 32 is flexible and the hook 31 and knife 33 are made of slightly hard material. The two hooks 31 of the two elastic sheets 21 can be clamped to contact to one another. Furthermore two cutting edges 331 are not in contact to one another in normal state. Moreover, when the knives 33 are pressed, the two hooks 31 will move outwards to separate from one another.

If the length from the hook 31 to the base 32 is A and the length from the base 32 to the knife 33 is B. It is preferably that A is greater than B.

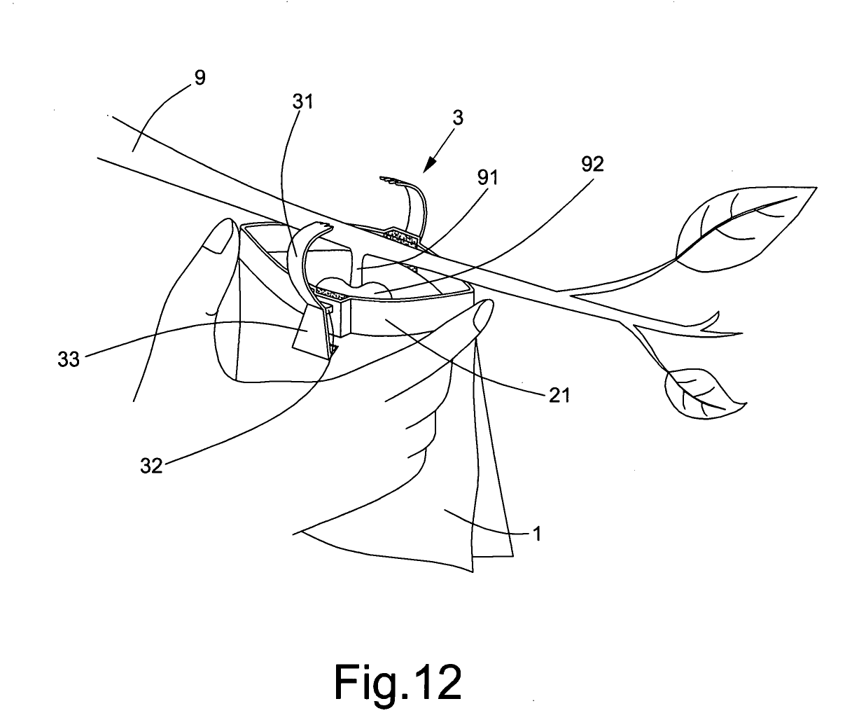

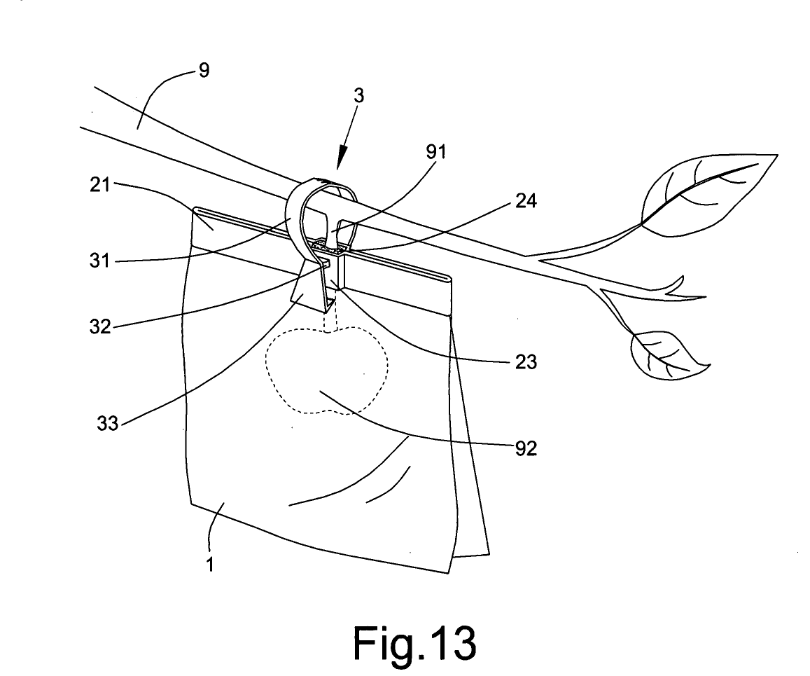

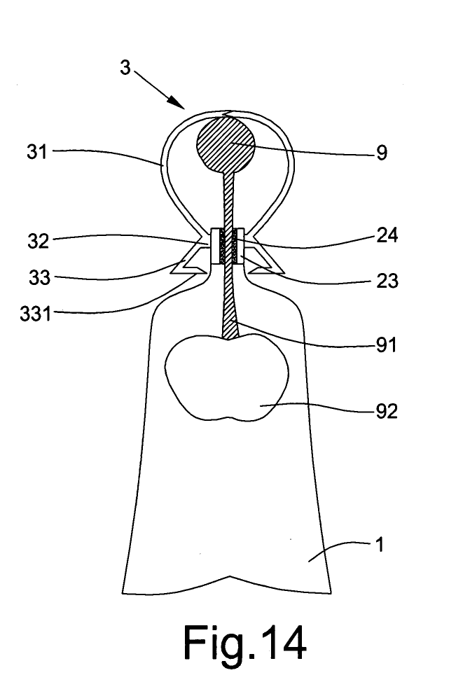

Referring to FIG. 12, when the bag 1 is used to enclose a fruit, two ends of the sealing clip 2 are pressed so that the two elastic sheets 21 expands outwards. Thus the bag 1 is opened. Then the bag 1 encloses a fruit 92. The sealing clip 2 is closed. The hooks 31 will clamp the branch 9, as shown in FIGS. 13 and 14. The foam protection layers 24 in the inner sides of the protrusions 23 will seal the gap between the two elastic sheets 21 so as to protect the stem 91.

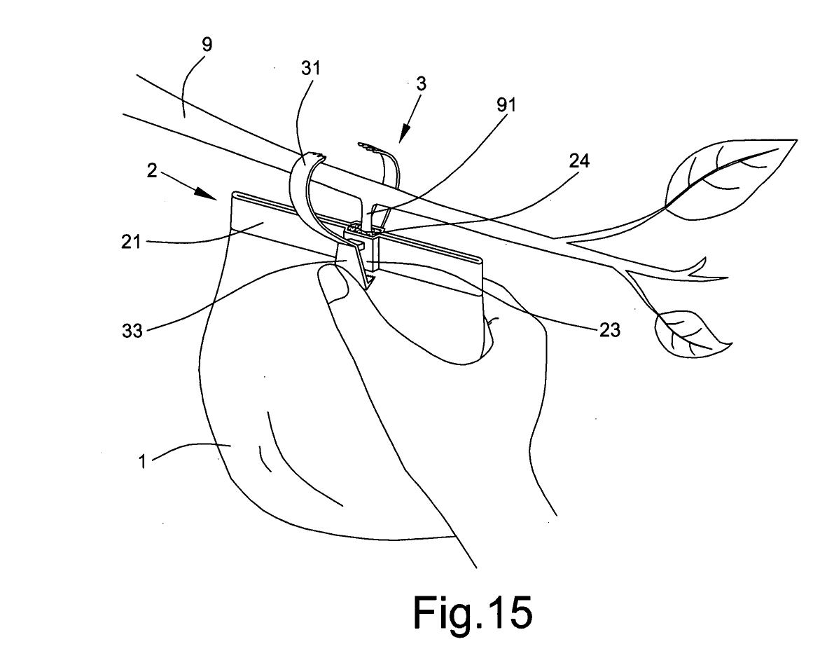

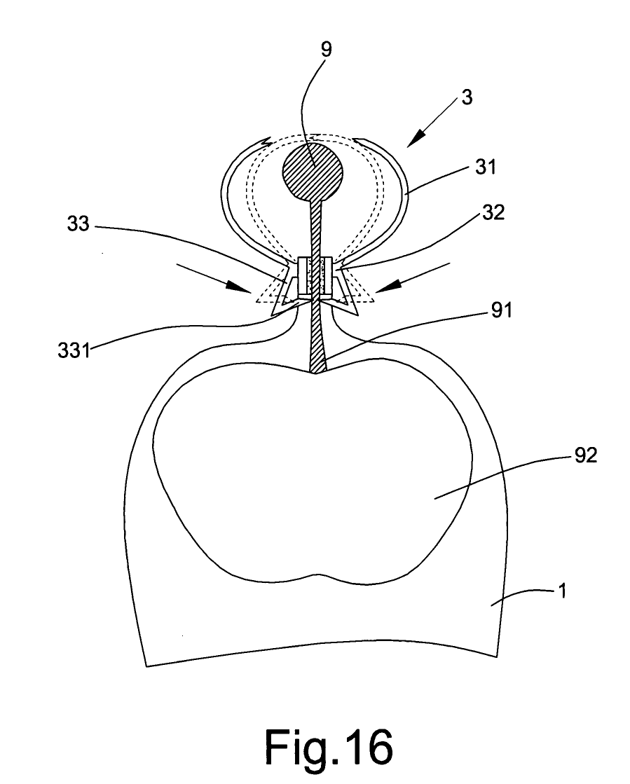

When the fruit 92 matures, as shown in FIGS. 15 and 16, the outer sides of the knives 33 are pressed and that the cutting edges 331 contacts with one another to form a small slit in the bag 1 and at this moment, the two hooks 31 move outwards. Then the stem 92 is cut. The bag 1 is separated from the branch 92. Thereby only one action is necessary for picking up the fruit.

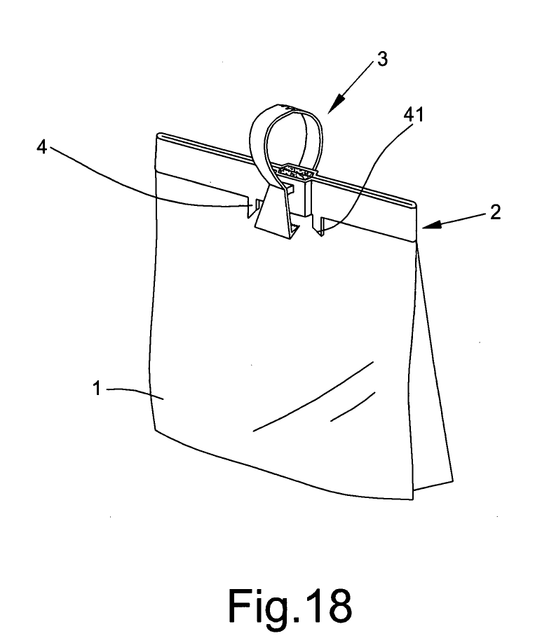

To avoid, the shift of the knife 33, as shown in FIG. 18, each elastic sheet 21 is extended with two projections 4 at two sides of the knife 33. Each projection 4 has an inclined edge 41 near the knives 33. In cutting, the inclined edge 41 can assist the knives 33 to a correct position.

A bottom of the bag 1 can be formed with a drain hole or vent hole (not shown). Moreover, a plurality of ribs can be installed in each elastic sheet 21 (not shown) for enhancing the structure of the elastic sheet 21. The ribs can be arranged transversally or longitudinally.

If the fruit is too large so that the bag 1 is also large, to make the sealing clip 2 can be opened by only one hand and the width of the sealing clip 2 is sufficient to take out a fruit, the sealing clip 2 may be formed as a V shape, that is a middle section of the sealing clip 2 protrudes upwards to make the width small. The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A quick cropper bag comprising;
a hollow bag having an opening end; and
a sealing clip at an opening end of the bag; the sealing clip including two elastic sheets; each elastic sheet having a protrusion.

2. The quick cropper bag as claimed in claim 1, wherein a hook extends from the elastic sheet.

3. The quick cropper bag as claimed in claim 1, wherein each elastic sheet is extended with a knife.

4. The quick cropper bag as claimed in claim 3, wherein the knife extends outwards from the protrusion of the elastic sheet.

5. The quick cropper bag as claimed in claim 1, wherein a base is connected to middle section of each elastic sheet and a hook extends upwards from the base and a knife extends downwards from the base.

6. The quick cropper bag as claimed in claim 5, wherein the hook has an approximate half moon shape and the knife has an approximate L shape and a lower end of the knife is formed as a cutting edge.

7. The quick cropper bag as claim in claim 5, wherein each elastic sheet is extended with two projections at two sides of the knife; each projection has an inclined edge near the knives; the inclined edge can assist the knives to a correct position in cutting a fruit.

8. The quick cropper bag as claimed in claim 1, wherein an interior of the protrusion is adhered with a foam protection layer.

9. The quick cropper bag as claimed in claim 1, wherein a plurality of ribs are installed on each elastic sheet.

10. The quick cropper bag as claimed in claim 1, wherein the sealing clip is formed as a V shape, that is a middle section of the sealing clip protrudes upwards to make the width small.
